(19) United States
(12) Patent Application Publication
(10) Pub. No.: US 2003/0004803 A1
(43) Pub. Date: Jan. 2, 2003

(54) Method for providing securities rewards to customers

(76) Inventors: H. Eiland Glover, Bowdon, GA (US); Stuart R. Hogue, New York, NY (US)

Correspondence Address: GARY CARY WARE & FREIDENRICH LLP, 1755 EMBARCADERO ROAD, PALO ALTO, CA, 94303-3340, US

(21) Appl. No.: 10/143,195

(22) Filed: May 9, 2002

Related U.S. Application Data
(60) Provisional application No. 60/289,914, filed on May 9, 2001.

(51) Int. Cl. G06F 17/60

(52) U.S. Cl. 705/14; 705/35; 705/36; 705/37

(57) ABSTRACT

A method for providing securities rewards to customers. To perform the method, a merchant registers a certain amount of stock for a reward program. Qualifying customers identify themselves when they make purchases from the merchant. The customers are given dollar value rewards for their purchases. A reward broker keeps track of the dollar value rewards during a reward period, and purchases an amount of the merchant's stock representing the total amount of dollar value rewards during the reward period. The reward broker then disaggregates the stock into individual customer accounts, based on the percentage of the dollar value rewards awarded to the corresponding individual customers.

### CROSS-REFERENCE TO RELATED APPLICATIONS

This application claims priority to U.S. Provisional Patent Application No. 60/289,914, filed on May 9, 2001, which is fully and completely incorporated herein by reference.

### FIELD OF THE INVENTION

This invention generally relates to securities rewards, and more particularly, to a method for providing securities rewards to customers, which allows a merchant to provide rewards of stock and cash to its customers.

### BACKGROUND OF THE INVENTION

The Securities Act of 1933 and the Securities Exchange Act of 1934 govern how a company (“reward broker”) can offer a program with underlying technology that enables other companies (“merchants”) to reward their customers (“customers”) with stock for their patronage.

The Securities Act of 1933 (the “'33 Act”) requires full disclosure of material facts in a registration statement preceding the offering of securities and prohibiting false representations and other fraudulent activities. The '33 Act stipulates that all securities sold from a company to the public be registered. Since merchants in such a program would be rewarding equity based on customers' spending, the '33 Act may require merchants to register the securities given to the customers (depending upon the configuration of the program). Section 15(a) of the Securities Exchange Act of 1934 (the “'34 Act”) generally requires any entity that uses the mails or any means of interstate commerce to effect, induce, or attempt to induce securities transactions to register as a broker-dealer with the Securities and Exchange Commission (SEC). Section 3(a)(4) of the '34 Act broadly defines “broker” as any person engaged in the business of effecting transactions in securities for the account of others. A dealer is defined in section 3(a)(5) of the '34 Act as “any person engaged in the business of buying and selling securities for his own account, through a broker or otherwise.”

The reward broker may act as the broker-dealer on behalf of the merchant rewarding the stock to the customer. Because the reward broker will act as the Broker-Dealer and the merchant will not, there are implications as to how the program can be conducted. Considering the foregoing rules and regulations, the present invention provides a method for rewarding customers with securities.

### SUMMARY OF THE INVENTION

One non-limiting advantage of the present invention is that it provides a method for allowing merchants to reward their customers with securities.

Another non-limiting advantage of the present invention is that it provides a method which allows a reward broker to enable a merchant to reward equity to consumers by use of a program offering that the merchant registers with the Securities and Exchange Commission (SEC).

Another non-limiting advantage of the present invention is that it provides a method for providing securities rewards to consumers that does not require a merchant to register an offering with the SEC.

Another non-limiting advantage of the present invention is that it provides a method for providing securities rewards to customers. To perform the method, a merchant registers a certain amount of stock for a reward program. Qualifying customers identify themselves when they make purchases from the merchant. The customers are given dollar value rewards for their purchases. A reward broker keeps track of the dollar value rewards during a reward period, and purchases an amount of the merchant's stock representing the total amount of dollar value rewards during the reward period. The reward broker then disaggregates the stock into individual customer accounts, based on the percentage of the dollar value rewards awarded to the corresponding individual customers.

According to one aspect of the present invention, a method is disclosed for providing securities rewards to customers. The method includes the steps of: registering a certain amount of stock of a merchant for a reward program; identifying qualifying customer purchases with the merchant; awarding dollar value rewards to customers for the qualifying customer purchases; obtaining a certain amount of the registered stock to distribute as rewards, based on purchase information received from a group of customers during a certain reward period; and disaggregating the obtained stock into individual customer accounts, based on the percentage of the dollar value rewards awarded to the corresponding individual customers.

According to another aspect of the present invention, a method is disclosed for providing reward incentives to customers. The method includes the steps of: identifying qualifying customer purchases with a merchant during a rewards time period; awarding cash rewards to customers for the qualifying customer purchases; calculating a total amount of cash rewards during the rewards time period; obtaining the total amount of cash from the merchant; and disaggregating the total amount of cash into individual customer accounts, based on the amount of cash rewards awarded to the corresponding individual customers.

These and other features and advantages of the invention will become apparent by reference to the following specification and by reference to the following drawings.

### BRIEF DESCRIPTION OF THE DRAWINGS

FIG. 1 is a flowchart describing how a merchant can register with the SEC, according to one embodiment of the present invention.

FIG. 2 is a flowchart describing how a customer may choose to receive stock or cash as a reward, according to one embodiment of the present invention.

FIG. 3 is a flowchart describing how a reward broker can enable a merchant to reward its customers with stock, according to one embodiment of the present invention.

FIG. 4 is a flowchart describing how the reward broker will disaggregate blocks of stock into customers accounts, according to one embodiment of the present invention.

FIG. 5 is a flowchart describing how the reward broker may enable a merchant to reward its customers with cash.

### DETAILED DESCRIPTION OF THE EMBODIMENTS

The present invention will now be described in detail with reference to the drawings, which are provided as illustrative examples of the invention so as to enable those skilled in the art to practice the invention. The present invention provides a method for providing securities rewards to consumers. The present invention may be implemented using software and hardware components, as would be apparent to those of ordinary skill in the art. The discussion below describes the present invention in the following manner: (i) Section I describes a method for providing securities rewards to customers by use of a program offering that is registered with the Securities and Exchange Commission (SEC); and (ii) Section II describes a method for providing rewards to customers by use of a program offering that is not registered with the SEC.

I. Consumer Stock Rewards Registration Model

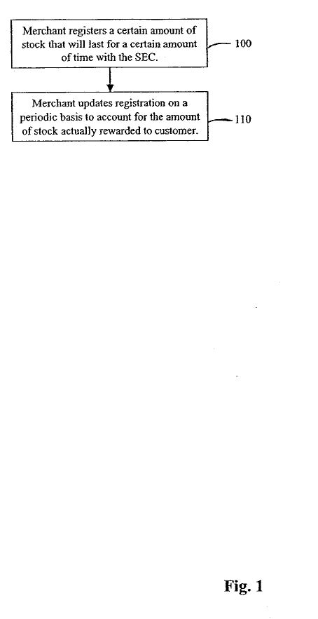

The first embodiment of the present invention provides securities rewards to customers by use of a program offering, which a merchant registers with the SEC. FIG. 1 illustrates a method by which a merchant can register such a program offering. First, a merchant will register in advance a certain number of shares to be used for this program, as shown in step 100. As the program proceeds, the merchant will periodically update the registration statement to reflect how much stock has actually been distributed to the customers, as shown in step 110.

A reward broker will administer a program that allows a merchant to reward its customers with fractional and whole shares of stock in the respective merchant. Customers may enroll at Reward Broker's web site, IVR system, or other manifestation of the reward broker. Details of the enrollment process are described in PCT application Ser. No. PCT/US00/19730, filed Jul. 20, 2000, which is fully and completely incorporated herein by reference.

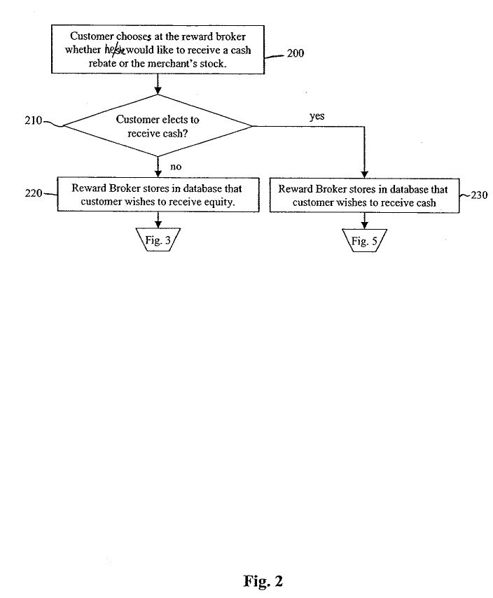

Customers may choose at enrollment (and potentially later in the process) whether they wish to receive cash or equity as a reward in the program. FIG. 2 illustrates a method by which a broker receives a customer's choice. In step 200, the customer chooses to receive cash or equity. In one non-limiting embodiment, this selection may be performed by entering data into the reward broker's web site. In step 210, the reward broker (or the reward broker's web site) determines whether the customer selected cash or equity. The customer's choice for either cash or equity is then stored in the reward broker's database, as shown in steps 220, 230.

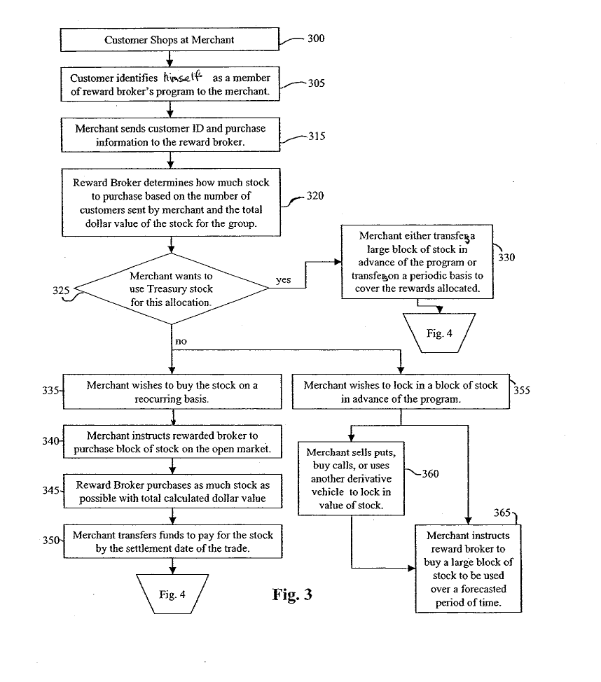

FIG. 3 illustrates a method used to enable a merchant to reward its customers with equity according to one embodiment of the invention. The following outlines how the customer will receive fractional and/or whole shares of stock if they choose equity as a reward. Reward broker participants identify themselves at the time of a sale to the participating merchants. In one embodiment, this occurs when a customer shops at a merchant's store, as shown in step 300, and identifies himself/herself as a qualifying member of the reward broker's program, as shown in step 305. The merchant then transmits the customer's reward broker ID and purchase information to the reward broker (which may be in batch format for all customers shopping in a certain period of time), as shown in step 315.

The reward broker's system determines the total dollar amount of stock it needs to reward all customers within a certain group, based on the group of customers and their corresponding purchase information sent to the reward broker from the merchant, as shown in step 320. A group of customers may be selected based on a certain reward period. For example, the group may comprise every qualifying customer making a purchase during the certain reward period. The merchant informs the reward broker (not necessarily at this point in time) that it would either like to purchase stock on the open market our to transfer the stock from its treasury to the reward broker, as shown in step 325.

If the merchant decides to transfer the stock to the reward broker from its treasury, the merchant can either complete the transfer in a block before the customers shop with the idea that the block will cover a number of reward periods or the merchant can make the transfers match every block to be disaggregated for the specific time period, as shown in step 330.

If the merchant decides to purchase the stock on the open market, much like in the above scenario, the merchant can purchase the stock on a reoccurring basis or before the purchase, as shown in steps 335, 355, respectively. The merchant can also use derivative financial instruments such as buying Call Options or selling Put Options to lock in the value of its stock if the merchant perceives the stock to be undervalued, as shown in step 360. If the merchant decides to buy a large block of stock, it can place the order either through the reward broker or through another broker and have the stock transferred to the reward broker, as shown in step 365.

If the merchant wishes for the reward broker to make the purchases on a periodic basis to fill the reward requests, the reward broker will make the purchases on the open market, as shown in step 340. The merchant purchase as much stock as possible with the total calculated dollar value, as shown in step 345, and will transfer funds to the reward broker for every sale before the trade is settled, as shown in step 350.

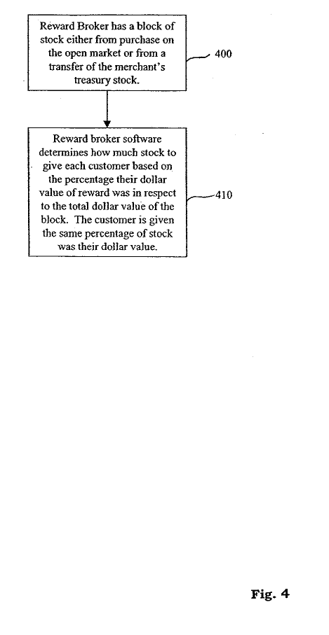

With all of the above scenarios, the reward broker will electronically disaggregate the blocks of stock into the customer accounts giving the customer accounts fractional and whole amounts of shares, as shown in FIG. 4. Particularly, the reward broker will identify a block of stock to separate, as shown in step 400. The reward broker will allocate the stock into individual customer accounts based on the percentage of the total dollar value of purchased/obtained stock that is represented by the dollar value of the individual customer's reward, as shown in step 410. In the preferred embodiment, the percentage of purchased stock that an individual customer receives may be given by the following equation: (Dollar Value of Individual Customer's Reward/Total Dollar Value of Stock Purchased)×100%. The customer will receive this same percentage in stock. These calculations may be performed autonomously using conventional programming algorithms, which may be executed by the reward broker's software.

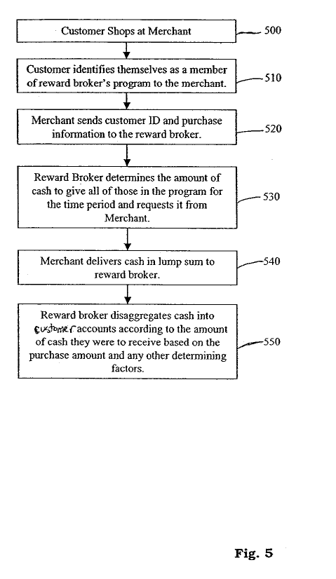

FIG. 5 illustrates the procedure taken when a customer opts to receive cash as a reward. In steps 500 and 510, the customer shops at the merchant and identifies himself as a member of the reward broker's program. In step 520, the merchant sends the Customer's ID and purchase information to the reward broker. The reward broker recognizes that the customer is to receive cash rather than stock, and bills the merchant for the cash reward, as shown in step 530. The merchant delivers an amount of cash to the reward broker (e.g., to cover rewards accruing during a particular reward period), as shown in step 540. The reward broker then disaggregates the cash and delivers the cash to the customers, as shown in step 550.

II. Consumer Stock Rewards Non-Registration Model

This embodiment is substantially similar to the above-described method. The only exception being that in order for the merchant to have to avoid registering a stock offering for the program, the reward broker must reward cash to the customers' accounts. The cash delivery method may be substantially identical to that illustrated in FIG. 5. Once a customer receives cash in his/her account, the cash may be invested according to the customer's desires. Particularly, a customer may specify that he/she wants the cash invested into the merchant's stock, or alternatively, the customer may choose to invest in other merchants in the reward brokers program, or in potentially other stocks and investment vehicles that may be offered by the reward broker. The reward broker will receive stock/investment requests or specifications from the customers, and will invest the cash accordingly. All stock may be purchased using the method outlined in PCT application Ser. No. PCT/US00/19730 filed Jul. 20, 2000, which is fully incorporated herein by reference.

What is claimed is:

1. A method for providing securities rewards to customers comprising the steps of:
registering a certain amount of stock of a merchant for a reward program;
identifying qualifying customer purchases with the merchant;
awarding dollar value rewards to customers for the qualifying customer purchases;
obtaining a certain amount of the registered stock to distribute as rewards, based on purchase information received from a group of customers during a certain reward period; and
disaggregating the obtained stock into individual customer accounts, based on the percentage of the dollar value rewards awarded to the corresponding individual customers.

2. The method of claim 1 wherein the value of the certain amount of registered stock obtained is equal to the total dollar value of rewards awarded during the certain reward period.

3. The method of claim 1 wherein the certain amount of stock to distribute as rewards is obtained from a purchase on a market.

4. The method of claim 1 wherein the certain amount of stock to distributed as rewards is obtained by a transfer of the merchant's treasury stock.

5. The method of claim 1 wherein the certain amount of stock to be distributed as rewards is obtained by purchasing options.

6. The method of claim 1 further comprising the step of:
updating the registered stock on a periodic basis to account for the stock awarded to customers.

7. The method of claim 1 further comprising the step of:
offering customers an option to receive cash in place of stock awards.

8. A method for providing reward incentives to customers, comprising the steps of:
identifying qualifying customer purchases with a merchant during a rewards time period;
awarding cash rewards to customers for the qualifying customer purchases;
calculating a total amount of cash rewards during the rewards time period;
obtaining the total amount of cash from the merchant; and
disaggregating the total amount of cash into individual customer accounts, based on the amount of cash rewards awarded to the corresponding individual customers.

9. The method of claim 8 wherein the individual customer accounts comprise investment accounts.

10. The method of claim 9 further comprising the steps of:
purchasing stock through an individual customer account.

11. The method of claim 10 wherein the stock purchased includes stock of the merchant.

12. The method of claim 10 wherein the stock purchased includes stock of another merchant.
